(19) United States
(12) Patent Application Publication
(10) Pub. No.: US 2026/0092567 A1
(43) Pub. Date: Apr. 2, 2026

(54) METHOD AND AIRCRAFT PROVIDED WITH A SYSTEM FOR DETERMINING A LEVEL OF POLLUTING EMISSION

(71) Applicant: AIRBUS HELICOPTERS, Marignane Cedex (FR)

(72) Inventor: Cyrille WEBER, Les Pennes Mirabeau (FR)

(73) Assignee: AIRBUS HELICOPTERS, Marignane Cedex (FR)

(21) Appl. No.: 19/270,805

(22) Filed: Jul. 16, 2025

(30) Foreign Application Priority Data
Sep. 30, 2024 (FR) FR2410463

(51) Int. Cl. F02C 9/00; B64D 31/00; B64F 5/60; G01M 15/14; G08B 21/18

(52) U.S. Cl. CPC F02C 9/00; B64D 31/00; B64F 5/60; G01M 15/14; G08B 21/182; F05D 2270/08

(57) ABSTRACT

An aircraft comprising a power plant provided with at least one combustion engine, and with a system for detecting polluting emissions, that comprises: i) at least one engine sensor per combustion engine that emits an engine measurement signal carrying a measured value of an engine parameter of the associated combustion engine; ii) at least one aircraft sensor that emits an aircraft measurement signal carrying a measured value of an aircraft parameter; and iii) a controller determining at least one produced amount of a pollutant emitted during the mission, as a function of the engine measurement signal and the aircraft measurement signal.

### CROSS REFERENCE TO RELATED APPLICATION

This application claims priority to French Patent Application No. FR 24 10463 filed on Sep. 30, 2024, the disclosure of which is incorporated in its entirety by reference herein.

### TECHNICAL FIELD

The present disclosure relates to an aircraft provided with a system for determining a level of polluting emission, as well as to a method for detecting a polluting emission in operation by an aircraft.

### BACKGROUND

An aircraft may emit pollutants in flight, such as carbon dioxide more simply known as “CO2”, nitrogen oxides more simply known as “NOx”, non-volatile particles more simply known as “nvPM” or unburned hydrocarbon particles more simply known as “UHC”.

Local regulations require some operators to declare the level of pollutants emitted.

Moreover, legislation in terms of polluting emissions tends to be increasingly restrictive. For example, the use of certain vehicles is subject to pollution criteria. Thus, the overflight of certain geographical areas may be controlled at a regulated level of polluting emissions.

However, it is difficult to accurately assess the polluting emissions of an aircraft. The value of a polluting emission from an aircraft is sometimes estimated for a range of aircraft, based on a generic flight profile. The emitted amount of a pollutant is thus estimated from a set of assumptions introducing approximations. Although effective, this approach may provide an inaccurate end result under conditions that differ significantly from the assumptions made, particularly for emissions of nitrogen oxides or fine particles.

Document US2018170575A1 relates to the monitoring of an aircraft engine using a wireless sensor network (WEMS), meeting emission standards and determines a maintenance schedule for an aircraft engine. Document US2023258101A1 describes an aircraft equipped with gas turbine engines, and aims to take advantage of different properties of various fuels for powering the engines, their operation or maintenance.

### SUMMARY

An object of the present disclosure is therefore to propose an innovative method and aircraft aiming to evaluate, in flight, the emitted amount of one or more pollutants.

Thus, the disclosure relates to an aircraft comprising a power plant provided with at least one combustion engine.

This aircraft comprises a polluting emission detection system that comprises:
at least one engine sensor per combustion engine, said engine sensor emitting an engine measurement signal carrying a measured value of an engine parameter of the associated combustion engine, this engine parameter influencing said polluting emission;
at least one aircraft sensor, said aircraft sensor emitting an aircraft measurement signal carrying a measured value of an aircraft parameter, this aircraft parameter influencing said polluting emission; and
a controller receiving, during a mission, the engine measurement signal and the aircraft measurement signal, the controller being configured to determine at least one produced amount of a pollutant emitted during said mission, as a function at least of the engine measurement and the aircraft measurement signal, the controller being configured to control at least one system of the aircraft by transmitting thereto a polluting emission signal as a function of said at least one produced amount.

The term “signal” denotes a digital, analog, optical or electrical signal, for example.

During a mission, the controller receives the engine measurement signal or signals and the aircraft measurement signal or signals. This controller is then provided with a model that is configured to determine one or more produced amounts, emitted during the current mission, of one or more pollutants, based at least on the engine measurement signal or signals and the aircraft measurement signal or signals. The pollutants emitted by an aircraft result both from the operation of its power plant and from the operating conditions of the aircraft.

Such a model may be determined by trials, computations and/or simulations. Such a model may take the form of one or more mathematical equations, an artificial intelligence and for example a neural network, a spreadsheet or the like.

The controller then emits one or more polluting emission signals as a function at least of the amount or amounts produced in order to control one or more systems of the aircraft as a function of the pollutant or pollutants emitted. A polluting emission signal may carry the produced amount of one or more pollutants, emitted during the mission, or an order to generate an alarm or an alert depending on the recipient system.

Thus, the aircraft is provided with a polluting emission detection system that is capable of determining, during a mission, and in particular during flight, the emitted amount of one or more pollutants, in a reliable and repetitive manner. This amount of one or more pollutants is then used to control one or more systems of the aircraft, in order to meet various regulations, or even to implement corrective actions in flight.

This aircraft may also comprise one or more of the following features, taken individually or in combination.

According to one possibility, said at least one produced amount of pollutant can be selected from: a produced amount of carbon dioxide, a produced amount of nitrogen oxides, a produced amount of non-volatile particles, a produced amount of unburned hydrocarbon particles, and optionally any other type of emission compounds deemed appropriate depending on the fuel used.

Thus, a polluting emission signal may carry at least one produced amount of carbon dioxide, and/or at least one produced amount of nitrogen oxides, and/or at least one produced amount of non-volatile particles, and/or at least one produced amount of unburned hydrocarbon particles. These various pollutants make it possible to properly evaluate the level of pollution generated by the aircraft.

The term “amount” may refer to any parameter making it possible to quantify the emission of a pollutant, such as a mass, a mass emitted per second, a number of particles or a number of particles per unit volume, for example.

According to one possibility compatible with the preceding possibilities, said at least one produced amount of a pollutant may be equal to an instantaneous amount of said pollutant emitted at a current instant or to the sum of the instantaneous amounts of said pollutant emitted since a start-up of the aircraft, or to the sum of the instantaneous amounts of said pollutant emitted since a start of a current flight phase.

A mission can be broken down in the usual way into various flight phases. The expression “flight phase” refers to a part of a mission wherein the aircraft has a particular behavior corresponding to a stored behavior. Thus, a mission may comprise a phase wherein the aircraft is stationary on the ground, a taxiing phase, a take-off phase, a landing phase, a cruising phase, a hovering phase, a climbing phase and a descending phase, for example.

At each iteration and for each pollutant studied, the controller calculates an instantaneous amount of this pollutant emitted by the aircraft. Each produced amount is a function of this instantaneous amount.

Optionally, the polluting emission detection system may comprise an adjustment human-machine interface in communication with the controller, the adjustment human-machine interface emitting a signal indicating whether a produced amount carried by the polluting emission signal must be equal to the current instantaneous amount or to the sum of the instantaneous amounts of this pollutant emitted since a start-up of the aircraft, or to the sum of the instantaneous amounts of this pollutant emitted since a start of a current flight phase. A pilot can then choose the type of information to be determined, according to his need.

Optionally, for the same pollutant, the polluting emission signal may carry the instantaneous amount, and/or the sum of the instantaneous amounts of this pollutant emitted since the start-up of the aircraft, and/or the sum of the instantaneous amounts of this pollutant emitted since the beginning of a current flight phase.

According to one possibility compatible with the preceding possibilities, said engine parameter may be chosen from the following list: a temperature inside the combustion engine measured using an engine temperature sensor, a flow rate of fuel flowing in the combustion engine measured using an engine flow meter, a pressure in the combustion engine measured using an engine pressure sensor, a power output by the combustion engine measured using an engine power sensor, an ageing of the engine evaluated by a computer such as an engine computer or a computer of an avionics system of the aircraft, a speed of rotation N1 of a gas generator of the combustion engine measured using a first engine speed sensor, a speed of rotation N2 of a working turbine of the combustion engine measured using a second engine speed sensor.

These engine parameters have an influence on the pollutants emitted by the aircraft. The polluting emission detection system can then measure one or more of these engine parameters. For example, the polluting emission detection system may at least measure the fuel flow rate, or even the power output by the combustion engine if such power is not evaluated at the aircraft level.

According to one possibility compatible with the preceding possibilities, said aircraft parameter may be selected from the following list: i) an external pressure, in an environment surrounding the aircraft, measured using an aircraft pressure sensor; ii) an external temperature in said environment measured using an aircraft temperature sensor; iii) a driving power generated by the power plant measured using an aircraft power sensor of the aircraft; and iv) a flow rate of fuel flowing to the combustion engine, measured using an aircraft flow meter.

These aircraft parameters have an influence on the pollutants emitted by the aircraft. The polluting emission detection system may then measure one or more of these aircraft parameters.

The polluting emission detection system may at least measure the external pressure and the external temperature, or even the driving power if the power output by a combustion engine is not evaluated at the engine level, or even a flow rate of fuel flowing to the combustion engine, in particular if this fuel flow rate is not evaluated at the engine level.

According to one possibility compatible with the preceding possibilities, the aircraft may comprise a parameterization human-machine interface (IHM1) for choosing a type of fuel, said parameterization human-machine a interface (IHM1) emitting parameterizing signal received by the controller (40), the controller (40) being configured to determine said at least one produced amount as a function of the engine measurement signal as well as the aircraft measurement signal and the parameterizing signal.

Different fuels can result in significantly different levels of pollution. This characteristic thus enables the controller to take into consideration the fuel used and therefore to obtain a more precise value of the produced amount of pollutant emitted.

According to one possibility compatible with the preceding possibilities, the polluting emission signal may carry said at least one produced amount of pollutant and said at least one system of the aircraft comprises at least one of the following processing members: a display receiving the polluting emission signal and configured to display said at least one produced amount of pollutant, a storage memory receiving the polluting emission signal and configured to store said at least one produced amount of pollutant.

Thus, a display may display at least one produced amount of one or more pollutants. A pilot may then take the displayed information into consideration when piloting the aircraft. The pilot may optionally follow a path compatible with the pollution generated. Alternatively or in addition, the pilot may act directly or indirectly on the operation of at least one combustion engine, for example by modifying the pitch of the blades of a rotor or a propeller in order to reduce the power to be supplied by the combustion engine, or on the external conditions by possibly changing altitude.

Alternatively or in addition, a memory may store a produced amount of one or more pollutants. Where applicable, a pilot may provide the produced amount of one or more pollutants to the local authorities at the end of his mission or the stored produced amount may be used on a subsequent flight to assess the health of a combustion engine.

According to one possibility compatible with the preceding possibilities, said at least one system may comprise an alarm generator receiving the polluting emission signal and configured to generate an alarm if said at least one produced amount of pollutant is greater than a stored threshold.

The polluting emission signal may comprise said at least one produced amount of one or more pollutants, and the alarm generator is configured to generate the alarm if it determines that a produced amount of a pollutant is greater than a respective stored threshold. Alternatively, the controller may determine whether a produced amount of a pollutant is greater than a stored threshold, the polluting emission signal transmitted to the alarm generator indicating whether the alarm should be issued accordingly.

Irrespective of the variant, an alarm may be generated if a produced amount of a pollutant is greater than a respective stored threshold. A pilot may then be informed that a pollution threshold is exceeded, in order to undertake corrective piloting actions, for example.

According to one possibility compatible with the preceding possibilities, the polluting emission signal carries at least one produced amount of pollutant and said measurement signal is transmitted to an autopilot system, the autopilot system being configured to modify a setting of the aircraft if said at least one produced amount of pollutant is greater than a stored emission limit.

The autopilot system can then act on the aircraft, possibly in order to comply automatically with a regulation. For example, the autopilot system may modify a longitudinal cyclic pitch of the blades of a helicopter rotor, possibly using a servo loop, based on the produced amount of a pollutant and the associated polluting emission limit, in order to modify the forward speed of the aircraft. Possibly, but not necessarily, the produced amount of a pollutant may be equal to the instantaneous amount in this case.

According to one possibility compatible with the preceding possibilities, the polluting emission signal may carry at least one produced amount of pollutant and said measurement signal is transmitted to a path generator, the path generator being configured to generate a diversion path if said at least one produced amount of pollutant is greater than a regulatory limit to be respected in a geographical area crossed by a current path of the aircraft.

This diversion path can be automatically displayed on a display. For example, but not necessarily, the produced amount may be equal to the instantaneous amount in this case.

The path generator may be of a conventional type. If the emitted amount of a pollutant is greater than such a regulatory limit, the path generator can automatically determine an alternative path making it possible to reach the desired destination without passing through the geographical area imposing a polluting emission lower than the currently emitted produced amount.

According to one possibility compatible with the preceding possibilities, said mission being carried out after a previous mission, the polluting emission signal may be transmitted to an alerter, the alerter being configured to generate an engine alert as a function of a comparison between the produced amount of pollutant and a produced amount of pollutant stored at the end of a previous mission or a previous equivalent flight phase, this engine alert optionally signaling a possible malfunction of the combustion engine.

The expression “equivalent flight phase” refers to two flight phases of the same type among the various flight phases described above. For example, the produced amounts of pollutant during two take-off phases are compared.

The polluting emission detection system can detect a significant drift in the emitted value of a pollutant, that may then be the representation of a breakdown or an engine malfunction.

For example, at the end of a mission or flight phase, the alerter or controller compares the produced amount of a pollutant emitted during the mission or flight phase divided by the duration of the mission or of this flight phase measured using a timer, and the corresponding produced amount of this same pollutant emitted during the previous mission or equivalent flight phase divided by the duration of the previous mission or equivalent flight phase. If the difference between these two amounts is greater than a stored limit, the alerter generates the engine alert.

The disclosure also relates to a method for detecting polluting emissions in flight of an aircraft comprising a power plant provided with at least one combustion engine.

The method comprises during a mission:
generating at least one engine measurement signal per engine using an associated engine sensor, said engine measurement signal carrying a measured value of an engine parameter of the associated engine influencing said polluting emission;
generating at least one aircraft measurement signal using at least one aircraft sensor, said aircraft measurement signal carrying a measured value of an aircraft parameter influencing said polluting emission;
receiving, by an aircraft controller, the engine measurement signal and the aircraft measurement signal;
determining, using the controller, at least one produced amount of a pollutant emitted during said mission as a function at least of the engine measurement signal and the aircraft measurement signal; and
controlling, using the controller, at least one system of the aircraft by transmitting thereto a polluting emission signal as a function of said at least one produced amount.

The method may comprise at least one of the following steps:
displaying, on a display of at least one system receiving the polluting emission signal, of said at least one produced amount of pollutant;
storing, in a storage memory of at least one system receiving the polluting emission signal, said at least one produced amount of pollutant;
generating an alarm, using an alarm generator of at least one system receiving the polluting emission signal, when said at least one produced amount of pollutant is greater than a stored threshold;
generating a diversion path, using a path generator of at least one system, when said at least one produced amount of pollutant is greater than a regulatory limit to be respected in a geographical area crossed by a current path of the aircraft;
generating an alert, using an alerter of at least one system receiving the polluting emission signal, as a function of a comparison between the produced amount of pollutant and a produced amount of pollutant stored at the end of a previous mission or an equivalent flight phase; and
modifying a setting of the aircraft, using an autopilot system of at least one system receiving the polluting emission signal, when said at least one produced amount of pollutant is greater than a stored polluting emission limit.

### BRIEF DESCRIPTION OF THE DRAWINGS

The disclosure and its advantages appear in greater detail from the following description of examples given by way of illustration with reference to the accompanying figures, wherein:

FIG. 1 is a diagram showing an aircraft according to the disclosure; and

FIG. 2 is a diagram showing a method according to the disclosure.

### DETAILED DESCRIPTION

Elements present in more than one of the figures are given the same references in each of them.

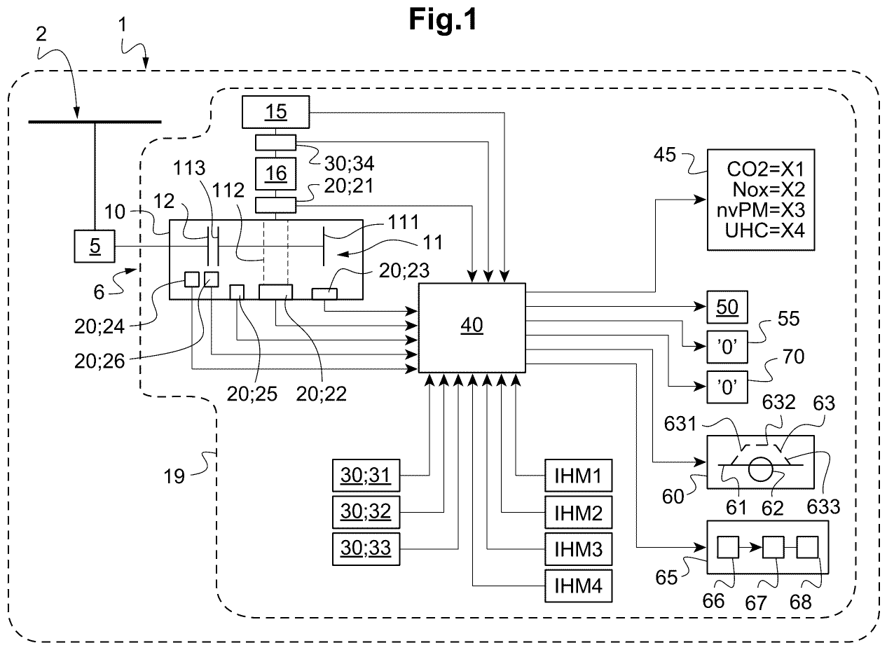

FIG. 1 shows an aircraft 1 according to the disclosure. This aircraft 1 comprises a power plant 6 that is provided with at least one combustion engine 10. This combustion engine 10 is a heat engine operating by combustion of a fuel. The one or more combustion engines 10 set in motion a drive train 5 to participate in the movement of the aircraft 1. For example, the aircraft 1 is a rotorcraft and the drive train 5 rotates at least one rotor 2.

For example, one or more combustion engines 10 are turboshaft engines. Such a turboshaft engine comprises a gas generator 11. The gas generator 11 is provided with a compression assembly 111 having at least one compression turbine, a combustion chamber 112 supplied with fuel by a fuel metering device 16 and with air by the compression assembly 111, and an expansion assembly 113 comprising at least one expansion turbine rotated by the gases leaving the combustion chamber 112 and constrained to rotate with the one or more compression turbines. In addition, the turboshaft engine comprises at least one working turbine 12, that is free or linked to the expansion assembly 113. The working turbine 12 is then kinematically and mechanically connected to a power shaft connected to the drive train 5 to set it in motion. Reference can be made to the literature in order to obtain a detailed description of such a combustion engine.

Optionally, one or more combustion engines 10 are piston engines. Such a piston engine comprises combustion chambers supplied with fuel in order to set in motion a power shaft.

Furthermore, each combustion engine 10 may be controlled by an engine computer 15, optionally dedicated to this engine 10.

FIG. 1 shows a power plant 6 having a single combustion engine 10 by way of example; however, the power plant 6 may have two or more combustion engines 10.

Regardless of the number and type of combustion engines 10, the aircraft 1 comprises a polluting emission detection system 19.

This polluting emission detection system 19 comprises at least one engine sensor 20 for each combustion engine 10. Each engine sensor 20 emits an engine measurement signal carrying the current value of an engine parameter of the corresponding combustion engine 10, this engine parameter influencing said polluting emission. The term “each” is used in the expression “each engine sensor 20” regardless of the number of engine sensors, i.e., both in the presence of a single engine sensor and in the presence of several engine sensors. Without specifying further, the same applies to the term “each” used in the following.

The term “sensor” should be understood to mean a physical sensor capable of directly measuring the parameter in question, but also a system that may comprise one or more physical sensors, as well as means for processing the signal that make it possible to provide an estimation of the parameter based on the measurements provided by these physical sensors. Similarly, the term “measurement” of this parameter refers to both a raw measurement from a physical sensor and a measurement obtained by relatively complex processing of raw measurement signals.

Furthermore, reference 20 designates any engine sensor, the references 21-24 designating particular sensors if necessary.

At least one or even each engine parameter may be chosen from the following list:
a temperature inside the combustion engine 10, this temperature being engine sensor of the conventional engine temperature sensor type 22, this temperature possibly being, for example, the so-called T4 temperature in the context of a turboshaft engine;
a flow rate of fuel flowing in the combustion engine 10, whether the combustion engine 10 is a turboshaft engine or a piston engine, this flow rate being measured, for example, using an engine sensor of the conventional engine flow meter type 21;
a pressure in the combustion engine 10, this pressure being measured using an engine sensor of the conventional engine pressure sensor type 23, this pressure possibly being, for example, a pressure in the gas generator 11 in the case of a turboshaft engine or even the pressure known by the expression P3 by a person skilled in the art;
a power output by the combustion engine 10 measured using an engine sensor of the engine power sensor type 24 of the aircraft 1, the engine power sensor 24 possibly comprising a speed of rotation sensor and a torque meter arranged on the power shaft of the combustion engine 10;
ageing of the combustion engine 10 evaluated by the engine computer 15, for example during a conventional engine health check, or by a computer of the aircraft configured for this purpose;
a speed of rotation N1, where applicable, of the gas generator 11 of the combustion engine 10, measured using a first conventional engine speed sensor 25; and
a speed of rotation N2 of a working turbine 12 of the combustion engine 10, measured using a second engine speed sensor 26.

Furthermore, the polluting emission detection system 19 comprises at least one aircraft sensor 30, the one or more aircraft sensors 30 each emitting an aircraft measurement signal carrying a measured value of an aircraft parameter, this aircraft parameter influencing said polluting emission. Reference 30 designates any aircraft sensor, and references 31-33 designate specific aircraft sensors, if necessary.

Optionally, the aircraft 1 comprises an aircraft pressure sensor 31 measuring an external pressure P0 prevailing in the external environment surrounding the aircraft 1.

Optionally, the aircraft 1 comprises an aircraft temperature sensor 32 measuring an external temperature TO prevailing in the external environment.

Optionally, the aircraft 1 comprises an aircraft power sensor 33 measuring the driving power generated by the power plant 6. For example, the aircraft power sensor comprises a speed of rotation sensor and a torque meter arranged on a shaft of the drive train 5, such as optionally a rotor mast constrained to rotate with the rotor 2.

Optionally, the aircraft 1 comprises a conventional aircraft flow meter type aircraft sensor 34 that measures a flow rate of fuel flowing out of and into the combustion engine 10.

Furthermore, the aircraft 1 comprises a parameterization human-machine interface IHM1 making it possible to choose a type of fuel, for example from a stored list of fuels. This parameterization human-machine interface emits a parameterization signal carrying the selected fuel.

The expression “human-machine interface” refers here and hereinafter to any known means of interaction, such as a button, touch screen, mouse, voice system, eye system, keyboard, or the like.

Furthermore, the polluting emission detection system 19 comprises a controller 40 receiving the engine measurement signal or signals and the aircraft measurement signal or signals, or even, if applicable, the parameterization signal.

The controller 40 may comprise, for example, at least one processor and at least one memory, at least one integrated circuit, at least one programmable system or at least one logic circuit, these examples not limiting the scope to be given to the term “controller”. The term “processor” may refer equally to a central processing unit or CPU, a graphics processing unit or GPU, a digital signal processor or DSP, a microcontroller, etc.

The controller 40 is configured to determine at least one produced amount of at least one pollutant emitted during the current mission, as a function of the engine measurement signal as well as the aircraft measurement signal, or even the parameterization signal. Moreover, the controller 40 is configured to emit, consequently, one or more polluting emission signals. Each polluting emission signal may carry either one or more produced amounts of at least one pollutant or of an order established from such a produced amount. Thus, the controller 40 can execute instructions enabling the produced amount or amounts of one or more pollutants and the polluting emission signal to be obtained as a function of each engine measurement signal and each aircraft measurement signal, or even the parameterization signal. The controller 40 may, for example, comprise a mathematical model, providing the instantaneous emitted amount of a pollutant, for example carbon dioxide, as a function of the data contained in the aircraft and engine measurement signals, or even the parameterization signal.

In particular, said at least one produced amount qt of a pollutant may be selected from a list comprising at least: a produced amount of carbon dioxide, a produced amount of nitrogen oxides, a produced amount of non-volatile particles, a produced amount of unburned hydrocarbon particles.

Optionally, the aircraft 1 may comprise a choice human-machine interface IHM2 transmitting a choice signal to the controller 40. An operator can use this choice human-machine interface IHM2 to select the pollutant or pollutants to be monitored.

At each instant, namely at each calculation iteration, the controller 40 can evaluate an instantaneous emitted amount for each pollutant monitored, in order to evaluate the produced amount of this pollutant.

According to a first variant, the controller 40 calculates the produced amount qt of a pollutant by considering that the produced amount is equal to the instantaneous amount qinst of this pollutant emitted at a current instant.

According to a second variant, the controller 40 calculates the produced amount qt of a pollutant by considering that the produced amount is equal to the sum of the instantaneous amounts qinst of this pollutant emitted since a start-up of the aircraft 1. For example, a starter or an engine computer sends a start signal to the controller 40 carrying the aircraft start-up time. In response, the controller 40 implements the detection of one or more pollutants.

According to a third variant, the controller 40 calculates the produced amount qt of a pollutant by considering that the produced amount is equal to the sum of the instantaneous amounts qinst of this pollutant emitted since a start of a current flight phase. For example, an avionics computer, that may be the controller 40, determines the change in flight phases. In response, the controller implements the detection of one or more pollutants.

Optionally, the aircraft 1 may comprise an adjustment human-machine interface IHM3 transmitting an adjustment signal to the controller 40. An operator can use this human-machine interface IHM3 in order to select the variant to be applied.

Optionally, the above variants can be implemented in parallel, the various amounts mentioned can all be evaluated at the same time for one or more pollutants.

Independently of the information carried by the polluting emission signal, the controller 40 is configured to control at least one system 45, 50, 55, 60, 65, 70 of the aircraft 1 by transmitting thereto a polluting emission signal that is a function of said at least one produced amount.

The aircraft 1 may then comprise one or more processing systems that receive the polluting emission signal or signals and change state accordingly.

Optionally, the aircraft 1 may comprise a selection human-machine interface IHM4 allowing an operator to select the systems 45, 50, 55, 60, 65, 70 to be controlled by the controller 40. The selection human-machine interface IHM4 transmits a selection signal to the controller 40, the controller 40 generating a polluting emission signal for each system 45, 50, 55, 60, 65, 70 to be controlled.

Thus, the aircraft 1 may comprise a display 45 receiving a polluting emission signal carrying at least one produced amount qt of a pollutant, and configured to display this produced amount qt. Such a display 45 may comprise a screen, a helmet display system, a head-up display system, or the like. According to the example illustrated, the display 45 displays a produced amount X1 of carbon dioxide CO2, a produced amount X2 of nitrogen oxides Nox, a produced amount X3 of non-volatile particles nvPM, and a produced amount X4 of unburned hydrocarbon particles UHC.

Alternatively or in addition, the aircraft 1 may comprise a storage memory 50 receiving a polluting emission signal carrying at least one produced amount qt of a pollutant, and configured to store the produced amount or amounts qt of the monitored pollutant or pollutants.

Alternatively or in addition, the aircraft 1 may comprise an alarm generator 55 receiving the polluting emission signal and configured to generate an alarm if one or more produced amounts qt are greater than one or more respective stored thresholds. In one possibility, the controller 40 is configured to determine whether a produced amount or amounts qt are greater than a respective stored threshold or thresholds, the polluting emission signal indicating in the affirmative that the alarm is to be emitted. According to another possibility, the polluting emission signal carries the produced amount or amounts, and the alarm generator is configured to determine whether or not at least one produced amount qt is greater than the associated stored threshold and to generate an alarm accordingly.

The alarm generator 55 may generate an alarm in the form of a visual alarm, for example emitting a light using a light-emitting diode or an equivalent, or one or more characters being displayed on a screen, an audible alarm, via a loudspeaker, and/or a haptic alarm, for example by means of a vibrating unit causing a member held or worn by an individual to vibrate.

Alternatively or in addition, the aircraft 1 may comprise an autopilot system 65. Such a piloting system 65 usually comprises an autopilot computer 66 controlling one or more actuators 67 acting on flight controls 68. Such flight controls 68 may take the form of an aerodynamic surface, the fuel metering device 16, or the like. The polluting emission signal carrying at least one produced amount qt of a pollutant can then be transmitted to the piloting system 65. Subsequently, the piloting system 65 is configured to modify a setting of the aircraft 1 if one or more produced amounts qt is greater than one or more respective stored emission limits. For example, the piloting system 65 may instruct the fuel metering device 16 of an engine 10 to change the fuel flow rate, or instruct an actuator 67 to change the blade pitch of a rotor 2.

Alternatively or in addition, the aircraft 1 may comprise a conventional path generator 60, such as, for example, a system known by the acronym FMS and the term “Flight Management System”. The polluting emission signal carrying at least one produced amount qt of a pollutant can then be transmitted to the path generator 60. The path generator 60 is then configured to generate a diversion path 63 if one or more produced amounts qt are greater than one or more respective regulatory limits to be respected in a geographical area 62 crossed by the current path 61 of the aircraft 1. The diversion path 63 is established to bypass the geographical area 62. The diversion path 63 may have a predetermined shape, comprising, for example, a straight bypass path 631 to the left or right of a geographical area to be avoided, an intermediate path 632 substantially parallel to the initial current path 61, and then a straight rejoin path 633 joining the initial current path 61.

Alternatively or in addition, the aircraft 1 may comprise an alerter 70 receiving the polluting emission signal. The alerter 70 is configured to generate an engine alert when a difference between the current produced amount and a produced amount stored in the memory 50 at the end of the previous mission for the same pollutant is greater than a stored threshold, this engine alert signaling a possible engine malfunction. According to one example, the controller 40 is configured to determine the requirement for a maintenance action. If the absolute value of a difference between a produced amount at the end of the current mission divided by the duration of the current mission and a corresponding produced amount qt at the end of the previous mission divided by the duration of the previous mission, is greater than a limit, the polluting emission signal indicates that the alert must be emitted.

The alerter 70 may generate an alarm in the form of a visual alarm, for example emitting a light using a light-emitting diode or an equivalent, or one or more characters being displayed on a screen, an audible alarm, via a loudspeaker, and/or a haptic alarm, for example by means of a vibrating unit causing a member held or worn by an individual to vibrate.

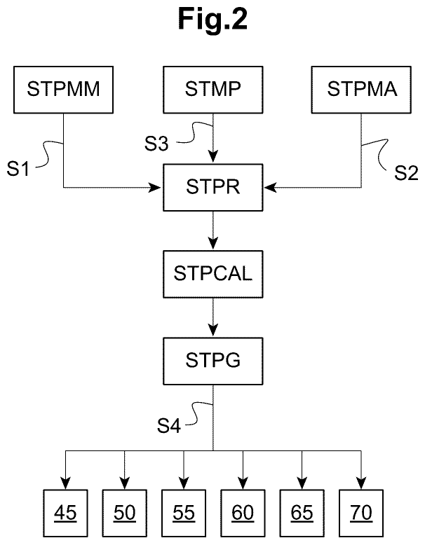

FIG. 2 illustrates an iteration of a method for detecting polluting emission in flight by an aircraft 1 according to the disclosure.

At each iteration, the method comprises generating STPMM at least one engine measurement signal S1 per combustion engine 10 using an associated engine sensor 20.

Moreover, the method comprises generating STPMA at least one aircraft measurement signal S2 using at least one aircraft sensor 30.

Optionally, the method comprises generating STMP at least one parameterization signal S3 using a parameterization human-machine interface IHM1.

Consequently, the method comprises receiving STPR, using the controller 40 of the aircraft 1, the engine measurement signal or signals S1 and the aircraft measurement signal or signals S2, or even the parameterization signal S3.

The method then comprises determining STPCAL, using the controller 40, at least one produced amount emitted during said mission, of a pollutant as a function of the aforementioned signals S1, S2 or even S3.

Finally, the method comprises emitting STPG, using the controller 40, at least one polluting emission signal S4 as a function of the engine measurement signal S1 and the aircraft measurement signal S2, or even the parameterization signal S3.

A polluting emission signal S4 may be received by the display 45, and/or the memory 50, and/or the alarm generator 55, and/or the path generator 60, and/or the autopilot system 65, and/or the alerter 70.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. An aircraft comprising a power plant provided with at least one combustion engine,
wherein the aircraft comprises a system for detecting polluting emissions, that comprises:
at least one engine sensor per combustion engine, the engine sensor emitting an engine measurement signal carrying a measured value of an engine parameter of the associated combustion engine, this engine parameter influencing the polluting emission;
at least one aircraft sensor, the aircraft sensor emitting an aircraft measurement signal carrying a measured value of an aircraft parameter, this aircraft parameter influencing the polluting emission; and
a controller receiving, during a mission, the engine measurement signal and the aircraft measurement signal, the controller being configured to determine at least one produced amount of a pollutant emitted during the mission, as a function at least of the engine measurement signal and the aircraft measurement signal, the controller being configured to control at least one system of the aircraft by transmitting thereto a polluting emission signal as a function of the at least one produced amount.

2. The aircraft according to claim 1,
wherein the at least one produced amount of pollutant is selected from: a produced amount of carbon dioxide, a produced amount of nitrogen oxide, a produced amount of non-volatile particles, a produced amount of unburned hydrocarbon particles.

3. The aircraft according to claim 2,
wherein the at least one produced amount of a pollutant is equal to an instantaneous amount of the pollutant emitted at a current instant or to the sum of the instantaneous amounts of the pollutant emitted since a start-up of the aircraft, or to the sum of the instantaneous amounts of the pollutant emitted since a start of a current flight phase.

4. The aircraft according to claim 1,
wherein the engine parameter is to be chosen from the following list: a temperature inside the combustion engine measured using an engine temperature sensor, a flow rate of fuel flowing in the combustion engine measured using an engine flow meter, a pressure in the combustion engine measured using an engine pressure sensor, a power output by the combustion engine measured using an engine power sensor, an aging of the engine evaluated by a computer, a speed of rotation of a gas generator of the combustion engine measured using a first engine speed sensor, a speed of rotation of a working turbine of the combustion engine measured using a second engine speed sensor.

5. The aircraft according to claim 1,
wherein the aircraft parameter is to be selected from the following list: an external pressure in an environment surrounding the aircraft measured using an aircraft pressure sensor, an external temperature in the environment measured using an aircraft temperature sensor of the aircraft, a driving power generated by the power plant measured using an aircraft power sensor, a flow rate of fuel flowing to the combustion engine measured using an aircraft flow meter.

6. The aircraft according to claim 1,
wherein the aircraft comprises a parameterization human-machine interface for selecting a fuel, type of the parameterization human-machine interface emitting a parameterizing signal received by the controller, the controller being configured to determine the at least one produced amount as a function of the engine measurement signal as well as the aircraft measurement signal and the parameterizing signal.

7. The aircraft according to claim 1,
wherein the polluting emission signal carries the at least one produced amount of pollutant and the at least one system of the aircraft comprises at least one of the following processing members: a display receiving the polluting emission signal and configured to display the at least one produced amount of pollutant, a storage memory receiving the polluting emission signal and configured to store the at least one produced amount of pollutant.

8. The aircraft according to claim 1,
wherein the at least one system comprises an alarm generator receiving the polluting emission signal and configured to generate an alarm if the at least one produced amount of pollutant is greater than a stored threshold.

9. The aircraft according to claim 1,
wherein the polluting emission signal carries at least one produced amount of pollutant and the measurement signal is transmitted to an autopilot system, the autopilot system being configured to modify a setting of the aircraft if the at least one produced amount of pollutant is greater than a stored emission limit.

10. The aircraft according to claim 1,
wherein the polluting emission signal carries at least one produced amount of pollutant and the measurement signal is transmitted to a path generator, the path generator being configured to generate a diversion path if the at least one produced amount of pollutant is greater than a regulatory limit to be respected in a geographical area crossed by a current path of the aircraft.

11. The aircraft according to claim 1,
wherein the mission being carried out after a previous mission, the polluting emission signal is transmitted to an alerter, the alerter being configured to generate an engine alert as a function of a comparison between the produced amount of pollutant and a produced amount of pollutant stored at the end of a previous mission or a previous equivalent flight phase, this engine alert signaling a possible malfunction of the combustion engine.

12. A method for detecting polluting emissions in flight by the aircraft comprising a power plant provided with at least one combustion engine,
wherein the method comprises the following steps:
generating at least one engine measurement signal per engine using an associated engine sensor, the engine measurement signal carrying a measured value of an engine parameter of the associated engine influencing the polluting emission;
generating at least one aircraft measurement signal using at least one aircraft sensor, the aircraft measurement signal carrying a measured value of an aircraft parameter influencing the polluting emission;
receiving, using a controller of the aircraft, the engine measurement signal and the aircraft measurement signal;
determining, using the controller, at least one produced amount of a pollutant emitted during the mission as a function at least of the engine measurement signal and the aircraft measurement signal; and
controlling, using the controller, at least one system of the aircraft by transmitting thereto a polluting emission signal as a function of the at least one produced amount.

13. The method for detecting a polluting emission in flight according to claim 12,
wherein the method comprises at least one of the following steps:
displaying, on a display of at least one system of the aircraft receiving the polluting emission signal, of the at least one produced amount of pollutant;
storing, in a storage memory of at least one system of the aircraft receiving the polluting emission signal, the at least one produced amount of pollutant;
generating an alarm, using an alarm generator of at least one system of the aircraft receiving the polluting emission signal, when the at least one produced amount of pollutant is greater than a stored threshold;
generating a diversion path, using a path generator of at least one system of the aircraft, when the at least one produced amount of pollutant is greater than a regulatory limit to be respected in a geographical area crossed by a current path of the aircraft;
generating an alert, using an alerter of at least one system of the aircraft receiving the polluting emission signal, as a function of a comparison between the produced amount of pollutant and a produced amount of pollutant stored at the end of a previous mission or an equivalent flight phase; and
modifying a setting of the aircraft, using an autopilot system of at least one system of the aircraft receiving the polluting emission signal, when the at least one produced amount of pollutant is greater than a stored polluting emission limit.
